(19) United States
(12) Patent Application Publication
(10) Pub. No.: US 2013/0237867 A1
(43) Pub. Date: Sep. 12, 2013

(54) MODULAR USER-EXCHANGEABLE ACCESSORY FOR BIO-SIGNAL CONTROLLED MECHANISM

(71) Applicant: NEUROSKY, INC., San Jose, CA (US)

(72) Inventors: Zavier Alexander, San Francisco, CA (US); Cheng-I Chuang, Saratoga, CA (US); KooHyoung Lee, Santa Clara, CA (US)

(73) Assignee: NEUROSKY, INC., San Jose, CA (US)

(21) Appl. No.: 13/768,139

(22) Filed: Feb. 15, 2013

Related U.S. Application Data
(60) Provisional application No. 61/607,955, filed on Mar. 7, 2012.

(51) Int. Cl. G06F 3/01

(52) U.S. Cl. CPC G06F 3/015
USPC 600/509; 600/300; 600/545; 600/546; 600/547; 600/549; 600/558; 600/586

(57) ABSTRACT

Modular user-exchangeable accessory for bio-signal controlled mechanism. In some embodiments, a biosensor and a feedback mechanism is disclosed. In some embodiments, a modular user-exchangeable accessory for bio-signal controlled mechanism includes detecting bio-signal using a bio-sensor; and sending a control signal to a modular user-exchangeable accessory for bio-signal controlled mechanism. In some embodiments, the biosensor is connected to a headset, wherein the modular user-exchangeable accessory is attachable to the headset. In some embodiments, the modular user-exchangeable accessory is shaped to resemble an animal ear.

### CROSS REFERENCE TO OTHER APPLICATIONS

This application claims priority to U.S. Provisional Patent Application No. 61/607,955 (Attorney Docket No. NEURP017+) entitled MODULAR USER-EXCHANGEABLE ACCESSORY FOR BIO-SIGNAL CONTROLLED MECHANISM filed Mar. 7, 2012 which is incorporated herein by reference for all purposes.

### BACKGROUND OF THE INVENTION

Biosensors (e.g., biosensor chips) exist and can be used to enable bio-signal features in various product categories. For example, consumer products are being developed to use such biosensor technology.

### BRIEF DESCRIPTION OF THE DRAWINGS

Various embodiments of the invention are disclosed in the following detailed description and the accompanying drawings.

Figure A illustrates a general outline of how the bio signal data is acquired, interpreted by the feedback mechanism, modified by the modular accessory, and how that accessory is attached in accordance with some embodiments.

FIG. 1 illustrates the overall design of a system, which utilizes EEG sensors to allow a user to control the movement of decorative cat ears through the voluntary control of their mental state in accordance with some embodiments.

FIG. 2 illustrates a feedback mechanism and accessories interpreting bio-signal data with motion in accordance with some embodiments.

FIG. 3 illustrates a feedback mechanism and accessories interpreting bio-signal data with light in accordance with some embodiments.

FIG. 4 illustrates a feedback mechanism and accessories, which make an electrical connection with the bio-signal device and interpret the bio-signal data based on their own electrical and physical design in accordance with some embodiments.

FIG. 5 illustrates a feedback mechanism paired with a modular accessory including a biosensor in accordance with some embodiments.

FIG. 6 illustrates a feedback mechanism and accessory that are physically separated from the biosensor device in accordance with some embodiments.

FIG. 7 illustrates a system, which detects a user's facial expressions with EMG or video sensors and/or body movement through EMG or accelerometers in accordance with some embodiments.

FIG. 8 illustrates a system, which utilizes voice recognition to modify the feedback behavior of a user detachable accessory in accordance with some embodiments.

FIG. 9 illustrates a system with a feedback mechanism, which mimics the display of bio-signal information without a biosensor device in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In some embodiments, a biosensor and a feedback mechanism is disclosed. For example, various products can be provided that utilize biosensor technology that can drive the action of a physical feedback mechanism, and which can also provide a user interface, entertainment value, behavioral training, and/or other benefits.

In particular, what is needed are solutions for allowing users to replace the moving element that can be controlled or manipulated in response to a bio-signal feedback with another accessory designed for the product or alter the bio-signal interaction experience in a meaningful way. Accordingly, a modular user-exchangeable accessory for bio-signal controlled mechanism is disclosed in accordance with some embodiments.

For example, accommodating a wide variety of uses for bio-signal data and individual user preference in manufactured products with solutions that facilitate simple and easy user customization of the bio-signal feedback mechanism can greatly enhance the flexibility and versatility of physical interfaces of various products using bio-signal feedback mechanisms.

In some embodiments, a biosensor device includes sensors capable of detecting various types of electrical bio-signals, such as blood-oxymetry, electrocardiography (ECG), electroencephalography (EEG), electromyography (EMG), electrooculography (EOG), galvanic skin response (GSR), and a temperature sensor (e.g., to measure skin or body temperature). For example, such signals can be use directly or further processed into measurements, such as heart rate, brainwave, muscle activation, eye tracking, and/or other socio-physiological states before being used in the biofeedback.

In some embodiments, the biosensor device includes sensors capable of capturing motion bio-signals, such as body movement using an accelerometer, facial expression using image or EMG sensors, and/or gesture recognition using image sensors. For example, these signals can be used directly or further processed into measurements, such as head orientation, emotional state, or packing order in a group or other socio-physiological states before being used in the bio-signal feedback.

In some embodiments, the biosensor device includes sensors capable of capturing audio bio-signals, such as heart sound, foot steps, flatulence, voice, and/or noise from body movement through sound sensors. For example, these signals can be used directly or further processed into measurements, such as recognized words, accent, fluency and emotional state, and/or other socio-physiological states before being used in the bio-signal feedback.

In some embodiments, socio-physiological information is displayed in a form directly observable by others and/or the user, such as motion, sound, light, vibration, and/or other feedback mechanisms. For example, removable or interchangeable display accessory can be attached to the feedback mechanism to modify how that feedback is presented to the viewer for functional and/or aesthetic purposes. The user can attach and detach the modifying accessory easily without disassembling the feedback mechanism or the biosensor device. In some embodiments, a modular user-exchangeable accessory for bio-signal controlled mechanism is disclosed that includes four main components. In some embodiments, a modular user-exchangeable accessory for bio-signal controlled mechanism includes the following main components: biosensor(s), a bio-signal processing unit, a feedback mechanism with accessory attachment points, and a modular accessory designed to attach securely with the feedback mechanism. For example, biosensors and the bio signal unit can be integrated into the structure of the product or placed on the accessory. Various other configurations will become apparent to those of ordinary skill in the art in view of the various embodiments described herein.

The bio-sensing device can be placed or fitted near or on the user to sense the bio-signal from the user. The user then interacts with the bio-sensing device. How and if the user touches the biosensors depends on the specific sensor configuration and what data is being collected. For example, a user collecting EEG data may have to attach several dry sensors to the head, or to collect ECG data, a user may have to press capacitive (e.g., non-contact) sensors to the chest. After bio-signal information is acquired, it can then be displayed or represented using a feedback mechanism as, for example, motion, sound light, vibration, or other observable feedback. This feedback can be a feature of the bio-sensing product and/or an accessory. For example, an accessory can modify how the feedback is presented in a functional and/or aesthetic manner.

Figure A illustrates the overall design of the system. The user (101) wears a biosensor device (102) that collects ECG, EEG, EMG and/or EOG data from the head or other body area. The bio-signal data is interpreted into a form of observable feedback by a mechanism (103). An accessory designed to attach or interact with that mechanism (104) influences the presentation of the bio-signal representation in a functional or purely aesthetic way. A variety of accessories with different functions, effects or styles may be applied to the same attachment scheme (105). The user is able to attach and detach the accessories with minimal effort or skill. The biosensor device and feedback mechanism are shown on a human head to clearly illustrate the concept, but is not limited to this location.

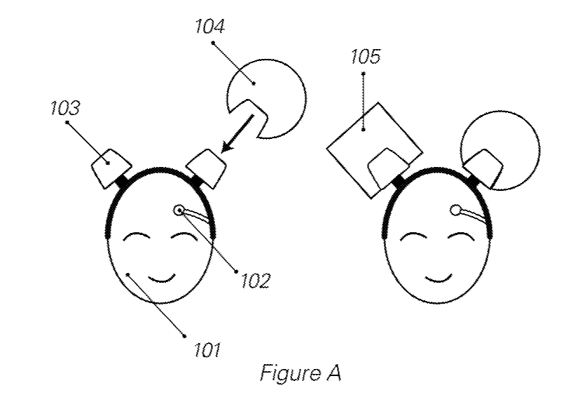

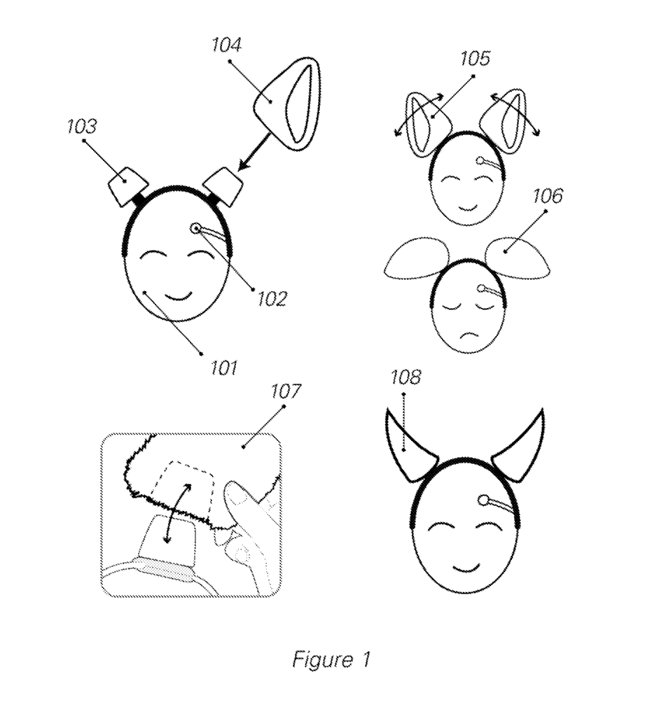

FIG. 1 illustrates the overall design of a system, which utilizes EEG sensors to allow a user to control the movement of decorative cat ears through the voluntary control of their mental state in accordance with some embodiments. In some embodiments, the device also responds to involuntary changes in the user's mental state. The user (101) wears a headset with a stainless steel passive, dry biosensor (102) that collects EEG data from the FP1 location on the forehead. The EEG data is interpreted by a biosensor module and motor control module inside the headset, which drive the movement of two servomotors (103). The servomotors spin on one axis in an arc from 0 degrees to 110 degrees. The user's mental state, as determined by EEG algorithms, dictates what position along the arc the servomotor will travel to (105, 106). For example, EEG algorithms can be used to determine whether a user is in a subjectively focused or subjectively relaxed state. The servomotors respond to these mental states with specific motions defined by pre-programmed firmware on the motor control module. An accessory shaped to resemble a cat ear and designed to attach to the servomotor housing (104) influences the presentation of the EEG signal and motor movement in an aesthetic manner.

In some embodiments, the ear accessory attaches onto the motor assembly via a friction fit method (107). The ear is composed of foam with a cavity shaped to correspond with the convex shape of the motor assembly. Surface friction between the two materials allows secure attachment as well a simple detachment process for the user. For example, a variety of accessories with different functions, effects or styles can be applied to the same attachment scheme (108), such as dog ears, horns, antennae, wings, elephant ears, other animal appendages, features of cartoon characters or sports team insignia. The user is able to attach and detach the accessories with minimal effort or skill. The biosensor device and feedback mechanism are shown on a human head to clearly illustrate the concept, but is not limited to this location. Other embodiments featuring bio-signals, such as blood-oxymetry, ECG, EEG, EMG, EOG, and/or GSR can use similar techniques as will now be apparent to one of ordinary skill in the art in view of the various embodiments described herein.

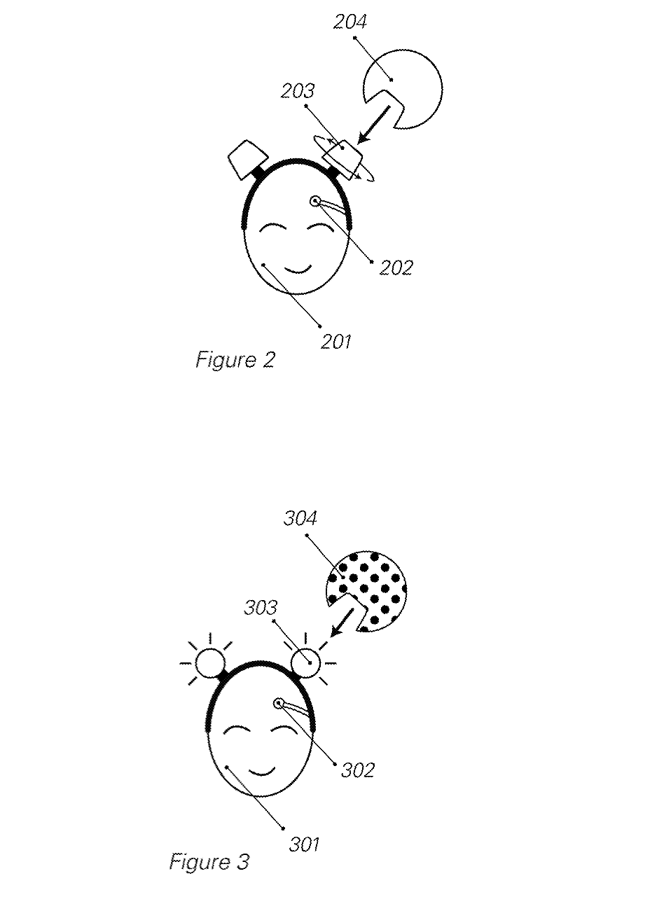

FIG. 2 illustrates a system, which utilizes the motion of a motor to interpret the bio-signal data into observable feedback in accordance with some embodiments. As shown, a user (201) wears a biosensor device (202) that collects ECG, EEG, EMG and/or EOG data from the head or other body area. The bio-signal data is interpreted into motion by the motor (203). An accessory designed to attach to the motor housing (104) is fastened, for example, via a friction fit, mechanical fastening, and/or other secure attachment method for the duration of use decided by the user. The accessory may be aesthetic and simply move with the motor or may include a mechanism of its own that utilizes the mechanical energy of the motor to operate another function. The user is able to attach and detach the accessories with minimal effort or skill. The biosensor device and feedback mechanism are shown on a human head to clearly illustrate the concept, but is not limited to this location.

FIG. 3 illustrates a system, which utilizes a light or network of lights to interpret the bio-signal data into observable feedback in accordance with some embodiments. The user (301) wears a biosensor device (302) that collects ECG, EEG, EMG, and/or EOG data from the head or other body area. The bio-signal data is interpreted into brightness or hue changes by the light (303). An accessory designed to attach to the light housing (104) is fastened via friction fit, mechanical fastening, and/or other secure attachment method for the duration of use decided by the user. The accessory may be aesthetic and simply filter, diffuse, or direct the light or may contain a mechanism of its own that further modifies the features of the light (e.g., brightness, hue, direction, diffusion, etc.). The user is able to attach and detach the accessories with minimal effort or skill. The biosensor device and feedback mechanism are shown on a human head to clearly illustrate the concept, but is not limited to this location.

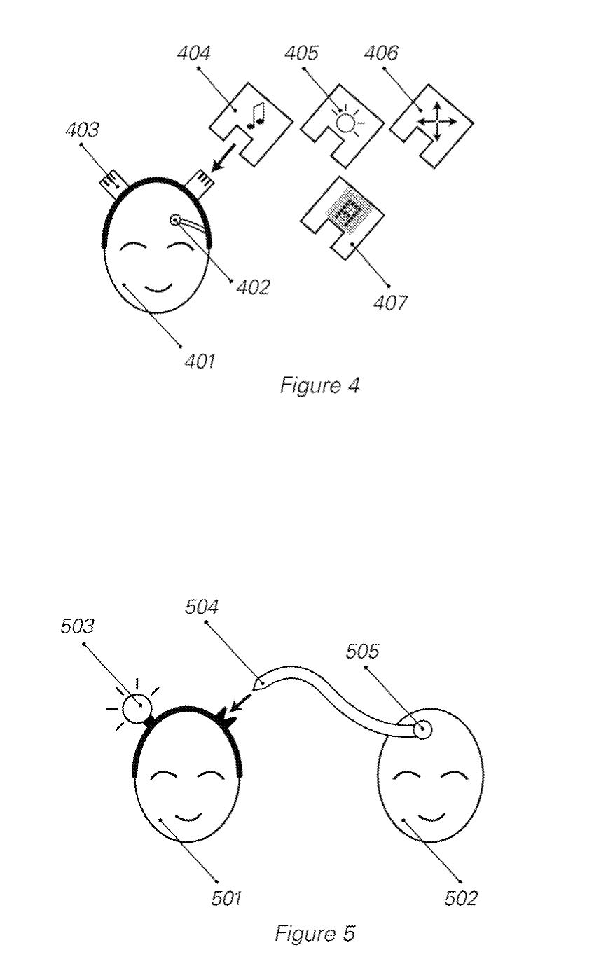

FIG. 4 illustrates a system, which utilizes a physical electrical connection (403) to communicate with various accessories that interpret the bio-signal data into various forms of observable feedback in accordance with some embodiments. The user (401) wears a biosensor device (402) that collects ECG, EEG, EMG, and/or EOG data from the head or other body area. The bio-signal data is interpreted into digital information that may then be interpreted by an appropriate accessory. An accessory designed to attach to the physical electrical connection is fastened via friction fit, mechanical fastening, and/or other secure attachment method for the duration of use decided by the user. The accessory makes an electrical connection with the biosensor device and interprets bio-signal data it receives into a feedback response dictated by the accessories design. As shown at 404, an accessory is illustrated that includes hardware that interprets the bio-signal data into sound or music. As shown at 405, an accessory is illustrated that includes hardware that interprets the bio-signal data into light. As shown at 406, an accessory is illustrated that includes hardware that interprets the bio-signal data into movement effects. As shown at 407, an accessory is illustrated that includes hardware that interprets the bio-signal data into symbolic representations of the data through LCD, e-paper or similar screen technology. The user is able to attach and detach the accessories with minimal effort or skill. The biosensor device and feedback mechanism are shown on a human head to clearly illustrate the concept, but is not limited to this location.

FIG. 5 illustrates a system, which provides a physical attachment point (504) for an accessory containing a biosensor (505) in accordance with some embodiments. The user (501) wears a biosensor device (505) that collects ECG, EEG, EMG, and/or EOG data from the head or other body area. The bio-signal data is interpreted into observable feedback, such as light, sound, and/or movement (503). For example, the biosensor attachment can be used to detect the user's bio-signals or another subject (502). The feedback mechanism (503) interprets the bio-signal data that the biosensor detects (505). The user is able to attach and detach the accessories with minimal effort or skill. The biosensor device and feedback mechanism are shown on a human head to clearly illustrate the concept, but is not limited to this location.

In some embodiments, multiple attachment points can be provided for multiple sensors that can, for example, detect different bio-signals (e.g., EMG, EOG, EEG, ECG, and/or GSR) or detect them through different methods. For example, these sensors can all detect the bio-signals of one or multiple users. There can also be multiple feedback mechanisms, which show the data from each sensor or a combination of data from multiple sensors as determined by an electronic algorithm or the physical design of the feedback mechanism. The user(s) is/are able to attach and detach the accessories with minimal effort or skill.

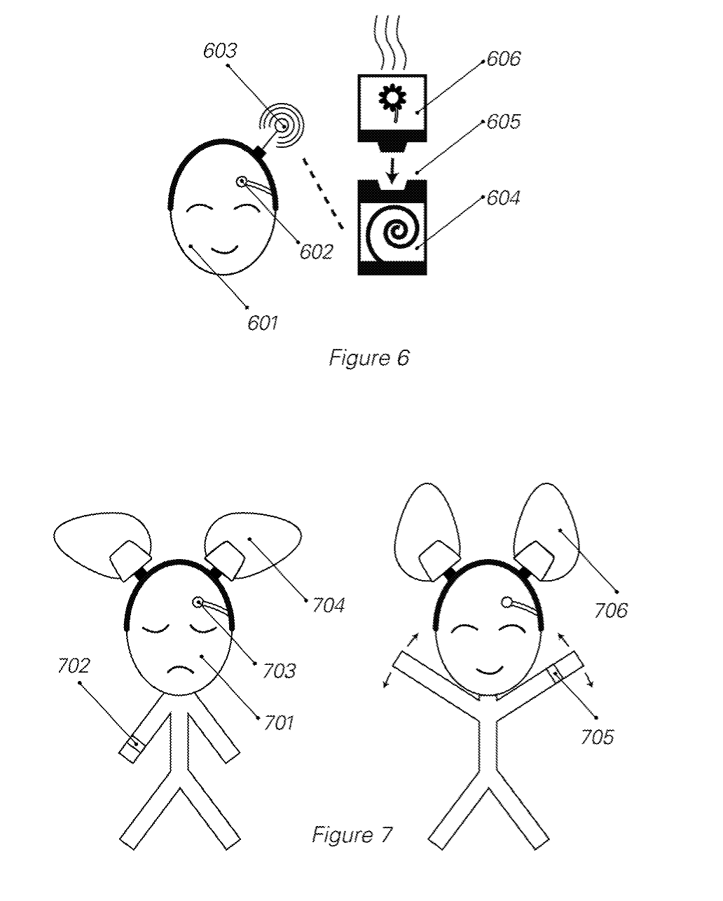

FIG. 6 illustrates a system, which utilizes a feedback mechanism (604), which is physically separated from the bio-signal device and sensor in accordance with some embodiments. The user (601) wears a biosensor device (602) that collects ECG, EEG, EMG, and/or EOG data from the head or other body area. The bio-signal data is communicated though wireless transmission (603) directly to the feedback mechanism (604) or to the feedback mechanism through an intermediate source, such as the Internet. As shown, the feedback mechanism shown here (604) includes a heating element. The thermal intensity is controlled by the user's bio-signal data. An accessory that includes a thermally sensitive scent designed to attach to the heating element housing (606) is fastened via friction fit, mechanical fastening, and/or other secure attachment method that conducts heat (605) for the duration of use decided by the user. The accessory reacts to the heat driven by the user's bio-signal data and interprets that data as scent released by the feedback mechanism. The user is able to attach and detach the accessories with minimal effort or skill. The biosensor device is shown on a human head to clearly illustrate the concept, but is not limited to this location.

In some embodiments, various feedback mechanisms are provided that interpret bio-signal information into light, sound, movement, and/or other observable feedback. The bio-signal feedback is modified by a modular accessory, which is easily attached and detached by the user with minimal effort or skill.

FIG. 7 illustrates a system, which detects a user's facial expressions (701) with EMG or video sensors (703) and/or body movement through EMG or accelerometers (702)(705) in accordance with some embodiments. As shown, a user removable accessory attaches onto the feedback mechanism (704) and the feedback mechanism reacts to the user's expression and body movement in the form of movement, light, vibration, and/or other observable feedback. Different facial expressions and/or body movements cause different reactions illustrated in the comparison between the accessory position marked (704) and (706). The user is able to attach and detach the accessories with minimal effort or skill. The biosensor device and feedback mechanism are shown on a human head and wrist to clearly illustrate the concept, but is not limited to these locations.

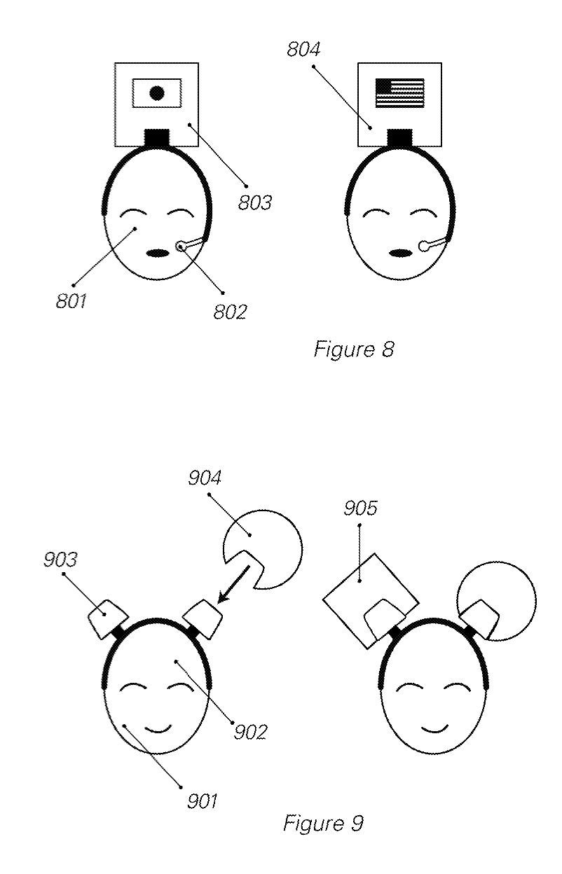

FIG. 8 illustrates a system, which utilizes voice recognition to modify the feedback behavior of a user detachable accessory (803) in accordance with some embodiments. The user (801) wears a voice-recognition device with an audio microphone (802). As shown at 803, an accessory is illustrated that includes hardware that interprets the voice data into symbolic representations dependent on the user's speech accent through LCD, e-paper, and/or similar screen technology. For example, detection of a Japanese accent can cause the display of a Japanese flag (803); detection of an American accent can cause the display of a US flag (804).

In some embodiments, various other feedback mechanisms can be provided that display voice data as physical motion, light, vibration, and/or other observable feedback are possible. The user is able to attach and detach the accessories with minimal effort or skill. The biosensor device and feedback mechanism are shown on a human head to clearly illustrate the concept, but is not limited to this location.

FIG. 9 illustrates a system with a feedback mechanism, which mimics the display of bio-signal information without a biosensor device in accordance with some embodiments. The user (101) wears a device (102), which does not collect bio-signal data, but can feature a decorative facsimile of a non-functioning biosensor. No bio-signal data is interpreted into observable feedback by the mechanism (103). The feedback mechanism displays motion, light, sound, and/or other feedback based on a pre-programmed behavioral pattern or a randomized sequence of behavior. In some embodiments, the feedback can be triggered by a source other than a bio-signal, such as a camera, an accelerometer, an IR sensor, an audio microphone, a communication with another device (e.g., wired or wirelessly), or a GPS unit. An accessory designed to attach or interact with that mechanism (104) influences the presentation of the observable feedback in a functional or aesthetic way. A variety of accessories with different functions, effects or styles can be applied to the same attachment scheme (105). The user is able to attach and detach the accessories with minimal effort or skill. The feedback mechanism is shown on a human head to clearly illustrate the concept, but is not limited to this location.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for a modular user-exchangeable accessory for bio-signal controlled mechanism, comprising:
a biosensor for detecting a bio-signal;
a processor configured to:
receive a bio-signal detected using the biosensor; and
send a control signal to a modular user-exchangeable accessory for bio-signal controlled mechanism; and
a memory coupled to the processor and configured to provide the processor with instructions.

2. The system recited in claim 1, wherein the further comprises:
a motor housing that includes a servomotor.

3. The system recited in claim 1, wherein the further comprises:
a motor housing that includes a servomotor, wherein the servomotor receives the control is signal for interpreting a processed bio-signal.

4. The system recited in claim 1, wherein the further comprises:
a motor housing that includes a servomotor, wherein the servomotor receives the control signal for interpreting a processed bio-signal, and wherein the servomotors spin on one axis in an arc from 0 degrees to 110 degrees.

5. The system recited in claim 1, wherein the further comprises:
a motor housing that includes a servomotor, wherein the servomotor receives the control signal for interpreting a processed bio-signal, and wherein the servomotors respond to a user's determined mental states with responsive motions.

6. The system recited in claim 1, wherein the biosensor is connected to a headset.

7. The system recited in claim 1, wherein the biosensor is connected to a headset, and wherein the modular user-exchangeable accessory is attachable to the headset.

8. The system recited in claim 1, wherein the biosensor is connected to a headset, wherein the modular user-exchangeable accessory is attachable to the headset, and wherein the modular user-exchangeable accessory is shaped to resemble an animal ear.

9. The system recited in claim 1, wherein the biosensor includes an electroencephalography (EEG) sensor.

10. The system recited in claim 1, wherein the biosensor includes an EEG sensor, and wherein the EEG sensor includes a stainless steel passive, dry biosensor.

11. The system recited in claim 1, wherein the biosensor includes an EEG sensor, and wherein the EEG sensor includes a stainless steel passive, dry biosensor that collects EEG data from the FP1 location on the forehead.

12. The system recited in claim 1, wherein the biosensor includes an electrooculography (EOG) sensor.

13. The system recited in claim 1, wherein the biosensor includes an electrocardiography (ECG) sensor.

14. The system recited in claim 1, wherein the biosensor includes an electromyography (EMG) sensor.

15. The system recited in claim 1, wherein the biosensor includes a galvanic skin response (GSR) sensor.

16. The system recited in claim 1, wherein the biosensor includes one or more sensors for detecting sound and/or body movement.

17. The system recited in claim 1, wherein the biosensor includes one or more sensors for detecting body temperature.

18. The system recited in claim 1, wherein the bio-signal includes an EEG signal, and wherein the EEG signal is processed to determine whether a user is in a focused state or in a relaxed state.

19. A method for a modular user-exchangeable accessory for bio-signal controlled mechanism, comprising:
detecting bio-signal using a bio-sensor; and
sending a control signal to a modular user-exchangeable accessory for bio-signal controlled mechanism, wherein the modular user-exchangeable accessory is attachable to the headset.

20. A system for a modular user-exchangeable accessory for bio-signal controlled mechanism, comprising:
a processor configured to:
receive a bio-signal from a biosensor; and
send a control signal to a modular user-exchangeable accessory for bio-signal controlled mechanism; and
a memory coupled to the processor and configured to provide the processor with instructions.
